(19) United States
(12) Patent Application Publication
(10) Pub. No.: US 2007/0026179 A1
(43) Pub. Date: Feb. 1, 2007

(54) PVC tube provided with a friction-reducing layer and method for the production thereof

(76) Inventors: Jan de Boer, Enkhuizen (NL); Hans-Jurgen Harms, Kothen (DE)

Correspondence Address: YOUNG & THOMPSON, 745 SOUTH 23RD STREET, 2ND FLOOR, ARLINGTON, VA, 22202, US

(21) Appl. No.: 11/492,050

(22) Filed: Jul. 25, 2006

(30) Foreign Application Priority Data
Jul. 27, 2005 (EP) 05106841.9

(51) Int. Cl. F16L 11/04

(52) U.S. Cl. 428/36.91

(57) ABSTRACT

PVC tube having a friction-reducing layer applied to the inside. This friction-reducing layer includes a material that can be applied with co-extrusion such that it bonds directly to the PVC material that is likewise extruded. Such a friction-reducing layer preferably includes an ethylene acrylate copolymer. It is also possible to use a plastic that in itself does not bond to PVC for such a friction-reducing layer. The desired bonding characteristics can, however, be obtained by mixing such a plastic before extrusion with a plastic that bonds to PVC. Preferably, a friction-reducing lubricant, such as silicone oil, is incorporated in the plastic. The invention relates in particular to an electrical conduit.

The present invention relates to a PVC tube having a friction-reducing layer applied to the inside.

Such a PVC tube is generally known in the state of the art. This can be, for example, an electrical conduit, where the inside of the tube has been provided with a layer of friction-reducing material to facilitate subsequent pulling through of electrical wiring.

Such a tube consists of an outer jacket of hard PVC material, a bonding layer applied inside this and a friction-reducing layer applied to the bonding layer. One example of such a PVC tube is found in DE 20320502-U1. In this publication it is indicated that, in contrast to polyethene tubes, it is necessary to apply an additional bonding layer because the friction-reducing layer and the PVC material cannot be bonded directly to one another, as a consequence of the lack of chemical compatibility. In the case of polyethene tubes such bonding is possible and in this case a polyethene material is also used for the friction-reducing layer.

The aim of the present invention is to avoid the complex and expensive structure that is proposed in DE 20320502-U1 on the one hand but, on the other hand, to maintain the use of PVC tubes, in particular in the field of electrical engineering.

This aim is realised with a PVC tube as described above in that said layer of friction-reducing material comprises a plastic that can be extruded with the PVC material of said PVC tube and bonds thereto.

Surprisingly, it has been found that in contrast to the preconceptions in the state of the art it is possible to bond a friction-reducing layer directly to the PVC material. By means of co-extrusion a PVC tube can be provided which has a friction-reducing layer applied to the inside thereof. A two-layer tube is easier to produce; extrusion problems that arise as a result of the use of a thin intermediate bonding layer are avoided.

Such a friction-reducing layer can be a layer based on ethylene acrylate copolymers. Examples of these are ethylene methyl acrylate and ethylene butyl acrylate. Ethylene methyl acrylate is mentioned in particular. Other bonding layers are ethylene vinyl acetate copolymers (EVA), ethylene acrylic acid copolymers (EAA), ethylene acrylic ester terpolymers, ethylene vinyl acetate terpolymers and anhydride-grafted polyolefins. It is assumed that the characterising functional groups make chemical combination of the copolymer with PVC possible, as a result of which bonding is promoted. Other types of functional groups can also contribute to an increased affinity for PVC. The various aspects can, for example, be determined on the basis of solubility parameter for the particular plastic that is applied directly to the PVC material as friction-reducing layer.

Other examples are plastics which under normal conditions do not bond to PVC material, such as polyethylene to which bonding agents have been added. These bonding agents are added before the co-extrusion, so that after co-extrusion, as described above, a two-layer tube is obtained with a PVC outer jacket and a friction-reducing layer applied directly thereto, that is to say without intermediate bonding layer. Such friction-reducing plastics can, for example, be mixed with the abovementioned substances that bond to PVC, for example ethylene vinyl acetate, but also anhydride-grafted copolymers, such as maleic anhydride, modified polyolefins, such as polyethylene modified with maleic anhydride or polypropylene modified with maleic anhydride.

In all cases lubricants can be added to the plastics in order to improve the friction-reducing properties. These lubricants are added before co-extrusion to the particular plastic that is going to form the friction-reducing layer. Examples thereof are silicones. However, it is possible to use other types of oil. The amount of lubricant, such as silicone oil, used is between 1 and 10% (m/m).

The invention also relates to a method for the production of a PVC tube, wherein with co-extrusion an outer layer consisting of PVC and a friction-reducing layer applied inside this are produced simultaneously and are bonded to one another. With this method the plastics described above can be used for the friction-reducing layer.

The PVC tubes are preferably made of hard PVC material (PVC-U). Both ribbed (flexible) and rigid tubes can be coated.

The invention will be explained in more detail below with reference to an example.

A PVC tube with a friction-reducing layer was produced by co-extrusion of PVC material and ethylene methyl acrylate. This ethylene methyl acrylate was a siliconised ethylene methyl acrylate in which approximately 4% (m/m) silicone oil had been incorporated.

In tests to determine the frictional resistance when pulling electrical cables (copper core and PVC sheath) through the PVC tube, it was found that the force required for this is comparable to the force required to pull such electrical wiring through a polythene tube, which polythene tube was provided with a friction-reducing layer based on polyethene.

Although the invention has been described above with reference to a preferred embodiment, variants that fall within the scope of the appended claims will be immediately apparent to those skilled in the art. It must also be understood that rights are claimed expressly for subject matter described in the dependent claims, both in combination with the independent claim and independently.

The PVC tube can also be applied as protection pipe for telecommunication and power cables or cable conveying ducts. A typical diameter range is 20 mm-200 mm.

A lubricated PVC duct is provided wherein the silicon oil is contained in a plastic layer.

1. PVC tube having a friction-reducing layer applied to the inside, characterised in that said layer comprises a plastic that can be extruded directly onto the PVC material of said PVC tube and bonds thereto.

2. PVC tube according to claim 1, wherein said layer comprises a polymer containing acrylic functional groups.

3. PVC tube according to claim 2, wherein said plastic comprises an ethylene acrylate copolymer.

4. PVC tube according to claim 3, wherein said layer comprises an ethylene methyl acrylate.

5. PVC tube according to claim 1, wherein said layer comprises a polyolefin modified with maleic anhydride.

6. PVC tube according to claim 1 wherein said layer comprises a plastic mixed with lubricants.

7. PVC tube according to claim 6, containing 1-10% (m/m) lubricant.

8. PVC tube according to claim 6, containing oil.

9. PVC tube according to claim 6, containing silicone oil.

10. PVC tube embodied as an electrical conduit.

11. Method for the production of a PVC tube, comprising the provision of a PVC tube with an internal friction-reducing layer by means of co-extrusion of PVC and a friction-reducing plastic, wherein said friction-reducing plastic is extruded directly onto the PVC.

12. Method according to claim 11, wherein said friction-reducing plastic is obtained by mixing a plastic provided with lubricant with a material that bonds to PVC.
